(19) United States
(12) Patent Application Publication
(10) Pub. No.: US 2026/0244521 A1
(43) Pub. Date: Aug. 20, 2026

(54) MOBILE COMPONENT TESTING

(71) Applicant: Evinced, Inc., Los Altos Hills, CA (US)

(72) Inventors: Yossi SYNETT, Hod Hasharon (IL); Gal MOAV, Tel Aviv (IL); Navin R. THADANI, Los Altos Hills, CA (US); Rebecca BIAZ, Modiin (IL); Asaf CHETRIT, Tel Aviv (IL); Matan SHAFRAN, Tel Aviv (IL); Illai ZEEVI, Tel Aviv (IL); Anton YERESHCHENKO, Vienna (AT); Andrii VOROPAI, Warsaw (PL)

(73) Assignee: Evinced, Inc., Los Altos Hills, CA (US)

(21) Appl. No.: 19/544,588

(22) Filed: Feb. 19, 2026

Related U.S. Application Data
(60) Provisional application No. 63/760,876, filed on Feb. 20, 2025.

(51) Int. Cl. G06F 11/07; G06F 9/451; G09B 21/00

(52) U.S. Cl. CPC G06F 11/0742; G06F 9/451; G09B 21/008

(57) ABSTRACT

A method and system for detecting accessibility issues in UI components of a mobile device software application is presented. The method and system includes: receiving, from a mobile OS accessibility framework via a mobile application test automation framework, a hierarchical representation of accessibility-exposed attributes of a selected component of a mobile application; obtaining a current value of the selected component as exposed through the accessibility-exposed attributes; performing an automated interaction with the selected component using the mobile application test automation framework, wherein an automated interaction is configured to simulate a user interaction; obtaining an updated value of the selected component after performing the automated interaction; and validating whether the updated value of the selected component reflects an expected change relative to the current value of the selected component, wherein a failure to reflect the expected change indicates an accessibility issue associated with the selected component.

### CROSS-REFERENCE TO RELATED APPLICATIONS

This application claims the benefit of US Provisional Application No. 63/760,876 filed on February 20, 2025, the contents of which are hereby incorporated by reference.

### TECHNICAL FIELD

The present disclosure relates to automated testing of accessibility compliance for graphical user interfaces of mobile software applications, including static and interaction-based validation of accessibility-exposed component attributes.

### BACKGROUND

Digital interfaces of mobile applications must be accessibility compliant. The Web Content Accessibility Guidelines (WCAG) provide guidelines and standards to determine when a digital interface is accessible to users with a variety of disabilities. These guidelines require developers to ensure that content is navigable and usable by users employing assistive technologies and alternative input modalities, including, by way of example, screen readers, voice control interfaces, switch-control interfaces, keyboard and focus-navigation services, and other accessibility services provided by the operating system.. Ensuring such navigability and usability includes, but is not limited to, ensuring that all images have descriptive alternative text exposing component roles, labels, values, states, and actions through platform accessibility interfaces, and satisfying visual accessibility requirements that can be evaluated from the user interface presentation (including, for example, color contrast and focus indicators). The WCAG guidelines are built around four core principles: perceivable, operable, understandable, and robust.

The perceivable principle ensures that information and user interface components are presented in ways that users can perceive. Key guidelines (from WCAG) include “1.1.1 Non-text Content,” which requires providing text alternatives for non-text content like images and icons so that they can be accessed by screen readers; “1.3.1 Info and Relationships,” which ensures that information that is conveyed visually is also conveyed programmatically, using semantic HTML and ARIA roles for screen readers; “1.3.2 Meaningful Sequence,” which makes sure content is in the correct reading order; “1.3.3 Sensory Characteristics,” which ensures content is not solely dependent on sensory characteristics, such as color or shape, to convey meaning; “1.3.5 Identify Input Purpose,” which requires input fields to be programmatically identified by screen readers; and “1.3.6 Identify Purpose,” which ensures UI components are clearly labeled so assistive technologies can determine their purpose.

The operable principle ensures that users can interact with the content and interface using a variety of input modalities and assistive technologies. Key guidelines (from WCAG) include “2.1.1 Keyboard,” which mandates that all functionality must be operable via a keyboard, benefiting users with screen readers; “2.1.2 No Keyboard Trap,” which ensures that users cannot get stuck in an interface element when using a keyboard; “2.4.1 Bypass Blocks,” which offers skip links for screen reader users to skip repetitive content; “2.4.2 Page Titled,” which ensures each page has a meaningful title that aids navigation; “2.4.3 Focus Order,” which ensures that the navigation order is logical, helping users using screen readers; “2.4.4 Link Purpose (In Context),” which ensures that links have clear, descriptive text; “2.4.6 Headings and Labels,” which requires clear headings and labels for better understanding; and “2.4.8 Location,” which provides navigation indicators to assist users who rely on assistive technologies or alternative input mechanisms.

The understandable principle ensures that content and interactions are clear and predictable. Key guidelines include, “3.2.1 On Focus,” which ensures that receiving focus does not trigger unexpected changes, preventing confusion for users; “3.2.2 On Input,” which prevents automatic changes when a user inputs data into a form, reducing errors; “3.2.3 Consistent Navigation,” which ensures that navigation mechanisms are consistent across the site; “3.2.4 Consistent Identification,” which ensures that components with the same function have consistent labels; “3.3.1 Error Identification,” which ensures that errors in forms are identifiable for screen readers; “3.3.2 Labels or Instructions,” which ensures forms include proper labels for assistive technologies; “3.3.3 Error Suggestion,” which provides suggestions for correcting errors in forms; and “3.3.4 Error Prevention” prevents major errors by confirming submission actions.

The robust principle focuses on creating content that can be reliably interpreted by a wide variety of user agents, including assistive technologies and other accessibility-related services. Key guidelines (from WCAG) include “4.1.2 Name, Role, Value,” which ensures that UI components expose their name, role, and value to assistive technologies, providing the necessary context for users; and “4.1.3 Status Messages,” which ensures that dynamic content updates are announced by screen readers, allowing users to stay informed of changes in the content without needing to manually refresh the page. These requirements are not limited to any specific set of tests and are intended to encompass present and future accessibility interaction patterns applicable to mobile device software applications.

For a mobile application to be compliant with accessibility standards, developers must ensure that the application correctly uses platform-native accessibility properties and interfaces that expose component roles, labels, values, states, and actions are programmatically available to mobile-device assistive technologies. Such properties and interfaces are provided by mobile operating systems and associated application frameworks and may differ across platforms. These mechanisms enable assistive technologies (including, by way of example, screen readers such as VoiceOver® on iOS® and TalkBack® on Android®, switch-based interfaces, voice control interfaces, keyboard navigation, and focus-navigation services) to interpret, announce, and interact with dynamic and static interface components presented by the mobile application.

However, there are several challenges with accessibility testing. First, many legacy testing tools are not integrated into the software development flow, meaning that accessibility checks are often an afterthought, conducted at the end of the development cycle rather than as part of the continuous testing process. This delay can make fixing issues more time-consuming and costly. In mobile application development, this problem is exacerbated by the fact that object models for mobile interfaces include limited information and vary greatly across development platforms.

Second, legacy tools often require developers to check each individual issue in isolation, making it difficult to focus on fixing components. This means that developers end up tackling small, isolated issues rather than addressing the underlying structural or design problems that affect multiple areas of a website.

A third problem is that testing mobile applications manually would require an immense amount of time and resources. This complexity increases the burden on testing teams, who would need to carefully evaluate every possible combination of roles and attributes to ensure full accessibility compliance, a task that becomes increasingly difficult as the number of components and interactions on a site grows.

It would therefore be advantageous to provide a solution that addresses the above challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include: receiving, from a mobile operating system (OS) accessibility framework via a mobile application test automation framework, a hierarchical representation of accessibility-exposed attributes of a selected component of a plurality of components of a mobile application; obtaining a current value of the selected component as exposed through the accessibility-exposed attributes, where a current value of a component is a current state associated with the selected component; performing at least one automated interaction with the selected component using the mobile application test automation framework, where an automated interaction is configured to simulate an user interaction; obtaining an updated value of the selected component after performing the at least one automated interaction; and validating whether the updated value of the selected component reflects an expected change relative to the current value of the selected component, where a failure to reflect the expected change indicates an accessibility issue associated with the selected component. Other embodiments of this aspect include corresponding computer systems, apparatus, and computer programs recorded on one or more computer storage devices, each configured to perform the actions of the methods.

In one general aspect, non-transitory computer-readable medium may include one or more instructions that, when executed by one or more processors of a device, cause the device to: receive, from a mobile operating system (OS) accessibility framework via a mobile application test automation framework, a hierarchical representation of accessibility-exposed attributes of a selected component of a plurality of components of a mobile application; obtain a current value of the selected component as exposed through the accessibility-exposed attributes, where a current value of a component is a current state associated with the selected component; perform at least one automated interaction with the selected component using the mobile application test automation framework, where an automated interaction is configured to simulate an user interaction; obtain an updated value of the selected component after performing the at least one automated interaction; and validate whether the updated value of the selected component reflects an expected change relative to the current value of the selected component, where a failure to reflect the expected change indicates an accessibility issue associated with the selected component. Other embodiments of this aspect include corresponding computer systems, apparatus, and computer programs recorded on one or more computer storage devices, each configured to perform the actions of the methods.

In one general aspect, a system may include one or more processors configured to: receive, from a mobile operating system (OS) accessibility framework via a mobile application test automation framework, a hierarchical representation of accessibility-exposed attributes of a selected component of a plurality of components of a mobile application; obtain a current value of the selected component as exposed through the accessibility-exposed attributes, where a current value of a component is a current state associated with the selected component; perform at least one automated interaction with the selected component using the mobile application test automation framework, where an automated interaction is configured to simulate a user interaction; obtain an updated value of the selected component after performing the at least one automated interaction; and validate whether the updated value of the selected component reflects an expected change relative to the current value of the selected component, where a failure to reflect the expected change indicates an accessibility issue associated with the selected component. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 is a flowchart of an example process for detecting accessibility issues in a selected component of a digital interface in a mobile application according to an embodiment.

FIG. 3 is an example mobile interface that illustrates an embodiment.

FIG. 4 is an example schematic diagram of a testing system according to an embodiment.

### DETAILED DESCRIPTION

The various disclosed embodiments include a method and system for detecting accessibility issues of individual components of digital interfaces deployed in mobile device software applications. The disclosed embodiments focus on testing a selected component independently of other components by validating whether accessibility- exposed attributes of that component, including static validation of one or more accessibility-exposed attributes without interaction and dynamic validation of whether accessibility-exposed attributes of that component are correctly updated before and after user interactions. As opposed to statically scanning a limited number of mobile component states to determine accessibility issues or, alternatively, performing only before/after interaction checks, the disclosed embodiments allow for generating a holistic view of component behavior across static and interactive states, including values and other properties exposed through platform accessibility interfaces in response to a variety of automated interactions. This approach allows for more efficient testing that uncovers more accessibility issues than traditional solutions.

Generating a holistic view of accessibility issues includes receiving, as input, a hierarchy view of accessibility-exposed attributes for a selected component of a multitude of components of a mobile application graphical user interface (GUI). The hierarchy view is retrieved from the mobile operating system or application test automation framework and represents the attributes and properties of the component that are available to assistive technologies. In some embodiments, screenshots or visual representations of the GUI may also be received to provide contextual reference for the component under test. A value of a component refers to the current state or data associated with that component, which may be independent (e.g., the label "Volume" displayed next to a slider) or dependent (e.g., "50" on a volume slider) on a user interaction. For example, the value of a toggle may be "on" or "off" depending on its state, the value of a slider may be a numeric value representing the selected amount, the value of a text field is the text the user has typed, the value of a radio button is the option that has been selected within a group, and the value of a tab is the specific tab that is currently active or selected in a tab list.

In some embodiments, one or more screenshots or other visual representations of the GUI are utilized to validate visual accessibility properties that are not fully determinable from accessibility-exposed attributes alone. By way of example, color contrast compliance of a slider track, label text, iconography, focus indicator, or state-dependent styling may be validated by analyzing pixel values within a screenshot corresponding to the component before and/or after interaction, and associating the analysis with the selected component under test.

Additionally, for a given component, the disclosed embodiments include obtaining one or more current values of accessibility-exposed attributes prior to interaction and one or more updated values after interaction. These values represent the state, label, role, value, or other accessibility-relevant properties of the same component. Accessibility testing is performed by validating whether the updated values reflect an expected change relative to the prior values based on the interaction performed.

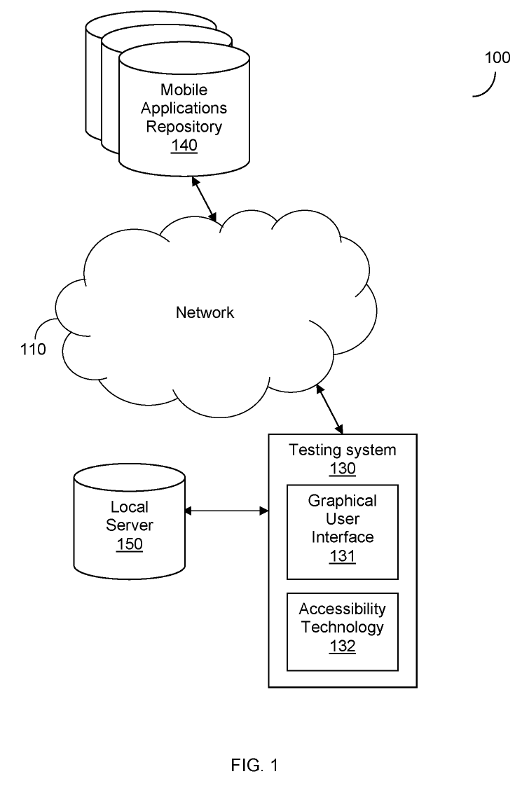

FIG. 1 shows an example network diagram 100 utilized to describe the various disclosed embodiments. In the example network diagram 100, a mobile applications repository 140, a testing system 130, and a local server 150 communicate via a network 110. The network 110 may be, but is not limited to, a wireless, cellular or wired network, a local area network (LAN), a wide area network (WAN), a metro area network (MAN), the Internet, the world wide web (WWW), similar networks, and any combination thereof.

It should be noted that testing system 130 is configured to operate locally within, or in conjunction with, a mobile application test environment. The testing system 130 may be integrated into a client-side test application or framework and does not require network-based communication during execution.

In some embodiments, the testing system 130 is configured to interface with a test automation framework capable of directly controlling a mobile device or mobile device simulator using platform-native testing APIs. Such a framework may include, by way of example and without limitation, iOS® automation frameworks based on XCUITest; Android® automation frameworks based on Espresso, UI Automator, or instrumentation testing APIs; WebDriver-compatible automation servers (e.g., Appium®) implemented using native testing frameworks; or the like. In some embodiments, the test automation framework is configured to retrieve mobile applications from a mobile applications repository 140 that is configured to store digital resources including, but not limited to, mobile application software. Mobile application software may be in development or deployed on user devices (e.g., available on commercial app stores).

The testing system 130 is configured to operate on a graphical user interface (GUI) 131 of a mobile device software application and access accessibility-related attributes exposed by the operating system (OS) for individual components. The testing system 130 is configured to execute automated interactions through the test automation framework, including launching and termination of applications, execution of touch-based interactions, scrolling, focus changes, and verification of component presence and state, while monitoring component attributes before, during, and after such interactions. The test automation framework is further configured to retrieve a hierarchical representation of accessibility-exposed attributes from the mobile operating system’s accessibility framework, wherein the hierarchical representation exposes accessibility-exposed attributes of components, including but not limited to component roles, labels, values, states, actions, and focus/navigation properties that are programmatically available to accessibility services such as VoiceOver® on iOS®, TalkBack® on Android®, voice control interfaces, switch-control interfaces, and keyboard/focus navigation services.

Accessibility technology 132 refers to OS-level assistive technologies capable of consuming accessibility attributes exposed by components, including screen readers and other non-visual interaction services, as well as services supporting alternative inputs and navigational paradigms. The testing system 130 is configured to evaluate whether component attributes are configured such that accessibility technology 132 can properly interpret component state and changes thereto, regardless of whether the assistive technology is actively enabled during execution.

A component is a interactive element that users engage with to perform an action or view information such as, but not limited to, a button (to trigger an action or event within the interface), a toggle (to switch between two states or options), a radio button (to select one option from a group of mutually exclusive choices), a text field (to input data, like typing text or entering values), a header (to define the title or category of a section), a combobox (to choose from a list of options), a checkbox (to select one or more options from a list), a slider (to adjust a value within a defined range), a progress bar (to indicate the completion status of a process or task), a modal window (to present additional content or actions in a temporary overlay), and a tooltip (to offer brief, contextual information about an element when users hover or focus on the element).

In an alternative embodiment, the testing system 130 may retrieve mobile application software from a local server 150. According to this embodiment, the local server 150 may include the code (written in a variety of programming languages depending on the deployment of the mobile application, e.g., Android® or iOS®). In another embodiment, results of the operations of the testing system 130 may be saved and stored on the local server 150.

The testing system 130 may be realized entirely on a local computing environment, including within a developer workstation, continuous integration environment, mobile device testing framework, or the like, without reliance on external servers or network connectivity.

The testing system 130 can be realized in software, hardware, firmware, or a combination thereof. The software comprises one or more computer-readable storage media storing instructions that, when executed by one or more processors, cause the system to perform one or more functions as described herein. The software may be implemented in various programming languages and may operate on different computing environments, including but not limited to cloud-based systems, distributed networks, standalone computing devices, or embedded systems. The software may include algorithms, machine learning models, or rule-based processing to achieve the described functionality. Various implementations may employ modular, service-oriented, or microservices architectures, and the system may interface with databases, APIs, or external services.

Although FIG. 1 shows example elements of the network diagram 100, in some implementations, the network diagram 100 may include additional elements, fewer elements, different elements, or differently arranged elements than those depicted in FIG. 1.

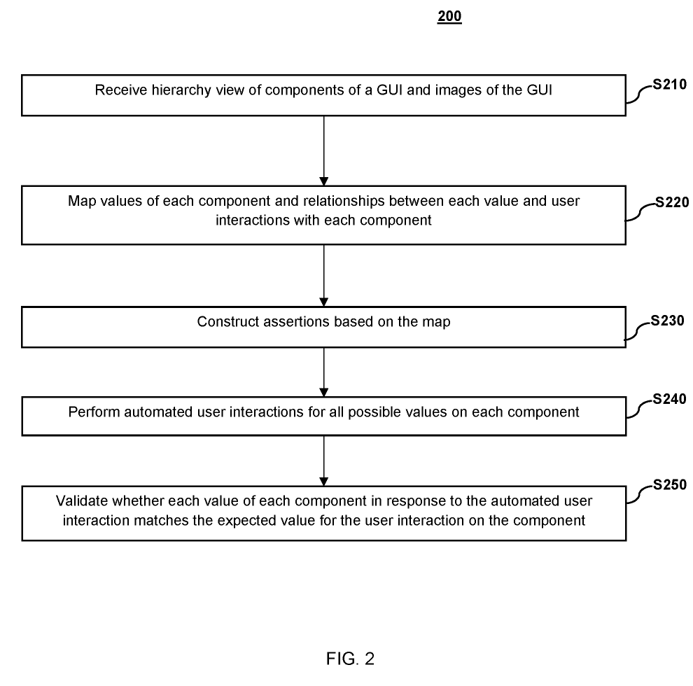

FIG. 2 is a flowchart of an example process 200 for detecting accessibility issues in a selected component of a digital interface in a mobile application according to an embodiment. In some implementations, one or more process blocks of FIG. 2 may be performed by testing system 130.

At S210, a hierarchy view of accessibility-exposed attributes for a selected component of a GUI is received. A hierarchy view is a representation of all components accessible by an assistive technology, e.g., assistive technology 132. As mentioned above, accessible components may include, but are not limited to, a button, a radio button, a text field, a header, a combobox, a checkbox, a slider, a progress bar, a modal window, and a tooltip. In some embodiments, the hierarchy view is retrieved from a mobile operating system (OS) accessibility framework via a mobile application test automation framework represents attributes that are machine-readable by assistive technologies. In some embodiments, visual representations of the GUI may also be retrieved to provide contextual reference for the selected component. In some embodiments, the visual representation is utilized to validate visual accessibility properties that are not fully determinable from accessibility-exposed attributes alone. By way of example, color contrast compliance of a slider track, label text, iconography, focus indicator, or state-dependent styling may be validated by analyzing pixel values within a screenshot corresponding to the component before and/or after interaction, and associating the analysis with the selected component.

At S220, one or more current values of the component are obtained from the hierarchy view. A value of a component is defined as a current state, label, role, or other accessibility-relevant attribute of the component, which can vary depending on the type of component. For example, the value of a checkbox may be true when checked or false when unchecked, reflecting whether the option is enabled or disabled. The value of a radio button may correspond to the selected option, such as “option1” or “option2,” representing which choice has been selected from a group. In the case of a text field, the value may be the actual text entered by the user, such as a name or address. For a slider, the value could be a numeric figure that indicates the position of the slider, like 50% for a midpoint value. For a tab component, the value would be the identifier of the tab currently selected, such as tab1 or tab2, indicating which section of content the user is viewing.

In some embodiments, static validation may be performed for the selected component without performing an automated interaction. Static validation includes validating one or more accessibility-exposed attributes of the component as currently exposed through the mobile operating system’s accessibility framework and/or as inferable from one or more visual artifacts associated with the component. In some embodiments, static validation includes verifying presence and/or non-emptiness of an accessible name, verifying presence and/or correctness of an accessible role/type, verifying presence and/or correctness of an accessible value where applicable to the role/type, verifying semantic correctness and consistency of accessibility-exposed attributes (including relationships between labels and controls and/or expected trait combinations), and determining whether the component satisfies one or more visual accessibility rules that are ascertainable without interaction, including, but not limited to, color contrast compliance.

At S230, an automated interaction is performed on the component using the mobile application test automation framework. The automated interaction is configured to simulate a user interaction. An automated interaction may include, for example, swiping a touchscreen a fixed distance in a certain direction to move a slider component, tapping to toggle a toggle component, entering text into a text field, selecting a radio button, changing focus among components, or performing an accessibility action associated with the component.

The OS on which the mobile application is hosted may have accessibility technology or an emulated accessibility technology enabled. The accessibility technology of emulation thereof is enabled during the performance of the automated user interactions to expose the accessibility technology to all user interactions, allowing the validation of whether the updated value of the component reflect an expected change relative to the current value of the component.

For example, an automated user interaction may be a swipe-up action using the Rotor® on a mobile device running iOS® to slide a slider component to a higher level e.g., from 10% to 30%. The accessibility technology enabled for this automated user interaction may be VoiceOver®.

At S240, an updated value of the component after performing the automated interaction is obtained. For example, after an automated interaction of swiping a touchscreen a fixed distance in a certain direction to move a slider component, the updated value of the slider component may be 30% when the current (starting) value of a slider is 10%.

At S250, it is validated whether the updated value of the component reflects an expected change relative to the current value of the component.

For example, if the updated value of a slider component is 30% when the slider component starts at a current (starting) value of 10% and an automated user interaction is an upward swipe of a particular distance and direction on a touchscreen that corresponds to a value change of 20% (as explained above), and the updated value of the slider component remains at 10% (or otherwise does not reflect an expected change of 20%), there is a mismatch between the updated value and current value. This mismatch indicates an accessibility issue or accessibility violation. In an embodiment, there may be a mismatch in current and updated values when an accessibility technology (e.g., a Screen Reader) does not read aloud “thirty percent,” when the updated value includes the accessibility technology reading aloud “thirty percent.” Such a mismatch indicates a failure to reflect the expected change (e.g., 20%) relative to the current value (e.g., 10%) in response to the automated interaction (e.g., swiping a slider to a degree that corresponds to a 20% change in value).

In some embodiments, validation may include applying matching criteria that define acceptable tolerances, including exact matches, numeric tolerance ranges, proportional changes, semantic equivalence, platform-specific accessibility comparison rules, or the like. An accessibility issue is detected when the updated values fail to satisfy the matching criteria.

In some embodiments, validation includes determining whether an accessibility-exposed attribute change would be readable by an assistive technology, such as whether a value, label, or state change is exposed through an accessibility interface even if no audible or visual output is produced.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

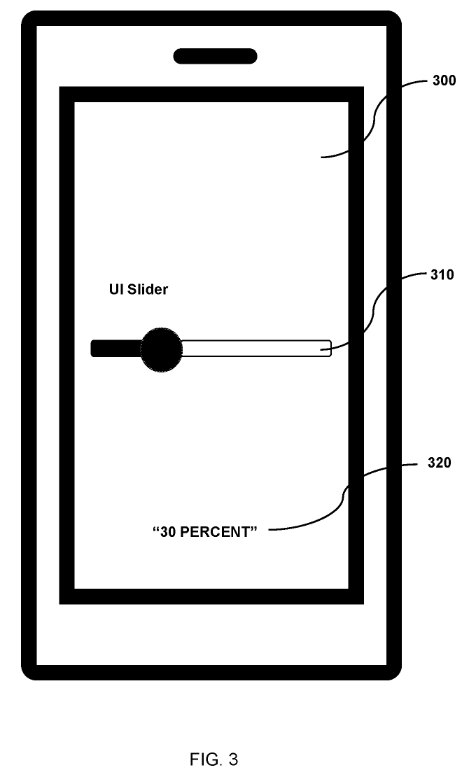

FIG. 3 is an example mobile interface 300 that illustrates an embodiment. In an embodiment, the embodiment illustrated in the example mobile interface 300 is performed by the testing system 130. In an embodiment, the example mobile interface 300 may be a GUI. In the example mobile interface 300, a slider component is demonstrated, but the disclosed embodiments should not be construed as limited to such a component.

In an embodiment, the slider component is tested according to the disclosed embodiments with respect to FIG. 2. The following includes a non-limiting example set of ten (10) tests for the slider component 310, the results (PASS or FAIL) of each test, and a suggested fix for the failed tests:

Test 1 of 10: UISlider#valid accessibility value

PASS: The UISlider has proper accessibility values for all slider states.

Test 2 of 10: UISlider#accessible name

PASS: The accessible name is not empty.

Test 3 of 10: UISlider#accessible type

PASS: The accessible type is not empty and it is set to slider.

Test 4 of 10: UISlider#accessible value

FAIL: The accessible value is empty.

Fix: Ensure the UISlider's accessibilityValue property is set correctly.

Test 5 of 10: UISlider#accessible value after interaction

PASS: The accessible value remains not empty after interaction.

Test 6 of 10: UISlider#accessible value update

FAIL: The accessible value is not updated or altered after interaction.

Fix: Implement code to dynamically update the accessibilityValue property.

Test 7 of 10: UISlider#assistive technology active (focus)

PASS: All assistive technologies correctly focus on the slider including Keyboard, VoiceOver, VoiceControl, Tap, Switch Access. (mocked)

Test 8 of 10: UISlider#assistive technology actions (increase/decrease)

PASS: Any assistive technology can correctly increase and decrease the slider value. (mocked)

Test 9 of 10: UISlider#color contrast before interaction

PASS: The slider meets color contrast requirements before interaction. (mocked)

Test 10 of 10: UISlider#color contrast after interaction

FAIL: Color contrast criteria is not met after interaction.

Fix: Ensure the color contrast ratio meets WCAG 2.1 AA standards.

In an embodiment, the slider component 310 failed three out of the ten example tests. According to such an embodiment, a report will be issued (for example, to a developer or user testing the component) indicating that accessibility issues are found.

In some embodiments, the non-limiting example set of tests are executed using a simulated implementation that provides predetermined responses for the associated component or dependency (e.g., “mocked”), rather than relying on the corresponding live application behavior or external system. Tests labeled as “mocked” should not be construed as the only tests capable of being mocked.

As an example, the slider component failed Test 6 of 10 because the “accessibility value is not updated or altered after interaction.” The accessibility value may be a VoiceOver output 320 that does not correctly read aloud the value of the slider in response to a user modification of the value.

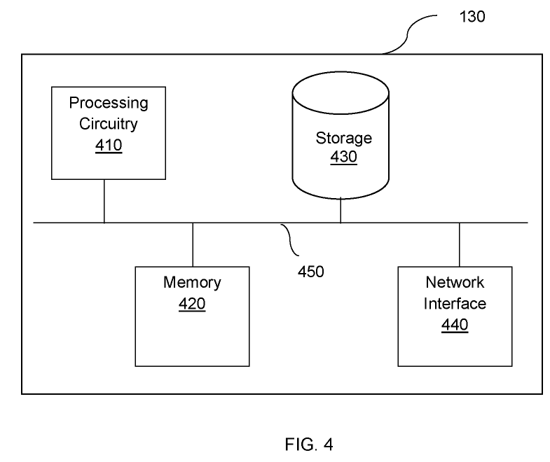

FIG. 4 is an example schematic diagram of a testing system 130 according to an embodiment. The testing system 130 includes a processing circuitry 410 coupled to a memory 420, a storage 430, and a network interface 440. In an embodiment, the components of the system 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read-only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 440 allows the testing system 130 to communicate with, for example, the mobile applications repository 140, and the like.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for detecting accessibility issues in a mobile device software application, comprising:
receiving, from a mobile operating system (OS) accessibility framework via a mobile application test automation framework, a hierarchical representation of accessibility-exposed attributes of a selected component of a plurality of components of a mobile application;
obtaining a current value of the selected component as exposed through the accessibility-exposed attributes, wherein a current value of a component is a current state associated with the selected component;
performing at least one automated interaction with the selected component using the mobile application test automation framework, wherein an automated interaction is configured to simulate a user interaction;
obtaining an updated value of the selected component after performing the at least one automated interaction; and
validating whether the updated value of the selected component reflects an expected change relative to the current value of the selected component, wherein a failure to reflect the expected change indicates an accessibility issue associated with the selected component.

2. The method of claim 1, wherein validating whether the updated value of the selected component reflects the expected change further comprises:
determining whether an accessibility-exposed attribute of the component is updated such that the attribute is readable by a mobile device assistive technology.

3. The method of claim 1, wherein the expected change is determined based on a predefined behavior of the selected component in response to the at least one automated interaction.

4. The method of claim 1, wherein the value of a component includes at least one of: an independent value, dependent value, a binary value, a numeric value, text inputted by a user into a text field, a selected option among a group of options, and a combination thereof.

5. The method of claim 1, wherein the mobile-device assistive technology is not required to be actively enabled during performance of the automated interaction.

6. The method of claim 2, wherein the current value and the updated value are accessibility attributes.

7. The method of claim 1, wherein an accessibility issue relates to whether the selected component exposes updated state information in a manner perceivable, operable, understandable, or robust according to accessibility standards.

8. The method of claim 1, further comprising: running the mobile application test automation framework to execute the at least one automated interaction with the selected component.

9. The method of claim 1, further comprising:
retrieving at least one visual representation of the selected component of the GUI; and
validating visual accessibility properties of the selected component that are not otherwise determinable.

10. The method of claim 9, wherein validating visual accessibility properties of the selected component further comprises:
validating any one of: sufficient color contrast of the selected component, sufficient focus indicators of the selected component, or sufficient state-dependent styling of the selected component.

11. The method of claim 1, wherein a mobile-device assistive technology is configured to assist visually-impaired users to navigate the mobile application.

12. The method of claim 1, further comprising:
prior to performing the at least one automated interaction with the selected component, statically validating at least one accessibility requirement without interacting with the selected component, including checking at least one of: presence of an accessible name, presence of an accessible role, presence of an accessible value, semantic correctness of accessibility-exposed attributes, or color contrast compliance based on a visual representation of the selected component, and wherein a failure of the static validation indicates an accessibility issue associated with the selected component.

13. A non-transitory computer-readable medium storing a set of instructions for detecting accessibility issues in a mobile device software application, the set of instructions comprising:
one or more instructions that, when executed by one or more processors of a device, cause the device to:
receive, from a mobile operating system (OS) accessibility framework via a mobile application test automation framework, a hierarchical representation of accessibility-exposed attributes of a selected component of a plurality of components of a mobile application;
obtain a current value of the selected component as exposed through the accessibility-exposed attributes, wherein a current value of a component is a current state associated with the selected component;
perform at least one automated interaction with the selected component using the mobile application test automation framework, wherein an automated interaction is configured to simulate a user interaction;
obtain an updated value of the selected component after performing the at least one automated interaction; and
validate whether the updated value of the selected component reflects an expected change relative to the current value of the selected component, wherein a failure to reflect the expected change indicates an accessibility issue associated with the selected component.

14. A system for detecting accessibility issues in a mobile device software application comprising:
one or more processors configured to:
receive, from a mobile operating system (OS) accessibility framework via a mobile application test automation framework, a hierarchical representation of accessibility-exposed attributes of a selected component of a plurality of components of a mobile application;
obtain a current value of the selected component as exposed through the accessibility-exposed attributes, wherein a current value of a component is a current state associated with the selected component;
perform at least one automated interaction with the selected component using the mobile application test automation framework, wherein an automated interaction is configured to simulate a user interaction;
obtain an updated value of the selected component after performing the at least one automated interaction; and
validate whether the updated value of the selected component reflects an expected change relative to the current value of the selected component, wherein a failure to reflect the expected change indicates an accessibility issue associated with the selected component.

15. The system of claim 14, wherein the one or more processors, when validating whether the updated value of the selected component reflects the expected change, are configured to:
determine whether an accessibility-exposed attribute of the component is updated such that the attribute is readable by a mobile device assistive technology.

16. The system of claim 15, wherein the current value and the updated value are auditory outputs.

17. The system of claim 14, wherein the expected change is determined based on a predefined behavior of the selected component in response to the at least one automated interaction.

18. The system of claim 14, wherein the value of a component includes at least one of:
an independent value, dependent value, a binary value, a numeric value, text inputted by a user into a text field, a selected option among a group of options, and a combination thereof.

19. The system of claim 14, wherein the mobile-device assistive technology is not required to be actively enabled during performance of the automated interaction.

20. The system of claim 14, wherein an accessibility issue relates to whether the selected component exposes updated state information in a manner perceivable, operable, understandable, or robust according to accessibility standards.

21. The system of claim 14, wherein the one or more processors are further configured to:
run the mobile application test automation framework to execute the at least one automated interaction with the selected component.

22. The system of claim 14, wherein the one or more processors are further configured to:
utilize retrieving at least one screenshot visual representation of the selected component of the GUI; and
validate visual accessibility properties of the selected component that are not otherwise determinable.

23. The system of claim 22, wherein the one or more processors, when validating visual accessibility properties of the selected component, are configured to:
validate any one of:
sufficient color contrast of the selected component, sufficient focus indicators of the selected component, or sufficient state-dependent style of the selected component.

24. The system of claim 14, wherein a mobile-device assistive technology is configured to assist visually-impaired users to navigate the mobile application.

25. The system of claim 14, wherein the one or more processors are further configured to:
prior to performing the at least one automated interaction with the selected component, statically validate at least one accessibility requirement without interacting with the selected component, including checking at least one of:
presence of an accessible name, presence of an accessible role, presence of an accessible value, semantic correctness of accessibility-exposed attributes, or color contrast compliance based on a screenshot or other a visual representation of the selected component, and wherein a failure of the static validation indicates an accessibility issue associated with the selected component.
